(19) United States
(12) Patent Application Publication
(10) Pub. No.: US 2023/0133295 A1
(43) Pub. Date: May 4, 2023

(54) SYSTEM AND METHOD TO ASSESS ABNORMALITY

(71) Applicant: INSTITUTE FOR INFORMATION INDUSTRY, Taipei City (TW)

(72) Inventors: Chia-Yu Lu, Taipei City (TW); Shang-Ming Jen, Taipei City (TW)

(21) Appl. No.: 17/534,430

(22) Filed: Nov. 23, 2021

(30) Foreign Application Priority Data
Nov. 4, 2021 (TW) 110141070

(51) Int. Cl. G06K 9/62; G06K 9/00; G06T 7/11; G06N 3/08; G06N 3/04

(52) U.S. Cl. CPC G06K 9/6257; G06K 9/628; G06K 9/00979; G06K 9/6218; G06K 9/6234; G06N 3/04; G06N 3/088; G06T 7/11; G06T 2207/20081; G06T 2207/20084; G06T 2207/30168

(57) ABSTRACT

A system and a method to assess abnormality are disclosed. The system is connected to an image capturing device and has multiple classification models and a processing module. Each one of the classification models is alternately trained by supervised learning and unsupervised learning. Parameters of the classification models are not identical. The processing module is connected to the classification models. The processing module receives a test image and outputs the test image to the classification models to respectively obtain multiple feature vectors of test images and to generate an abnormality assessment information.

### CROSS REFERENCE TO RELATED APPLICATIONS

The present application claims priority to Taiwan application No. 110141070, filed on Nov. 04, 2021, the content of which is hereby incorporated by reference in its entirety.

### BACKGROUND OF THE INVENTION

### 1. Field of the Invention

The present application relates generally to an assessment system and an assessment method, and more particularly to a system and a method to assess abnormality.

### 2. Description of Related Art

With the development of technology, the applications of artificial intelligence (AI) become more and more diversified. Performing the image detection via an image recognition model is an example. The pre-training procedure of the image recognition model is closely related to its performance. There are a lot of model training methods in the technical field of the artificial intelligence, wherein “supervised learning” is a mainstream method. The fundamental of the supervised learning is to collect a large number of image samples and manually apply a respective feature label to each image sample. The feature label is the objective for the image recognition model to recognize. The image recognition model is trained according to the large number of the image samples and their feature labels.

It is to be understood that the performance of the image recognition model is limited to the contents of the image samples and their feature labels. Namely, the image recognition model trained no more than the supervised learning fails to recognize an objective excluded from said feature labels. For example, in the training by the supervised learning, known abnormalities of the image samples are labelled as feature labels, such that the image recognition model can learn no more than the known abnormalities. When the image recognition model runs at the worksite practically, the image recognition model may receive a product image from a camera of a production line. Although the image recognition model can recognize the known abnormalities, the image recognition model fails to recognize unknown abnormalities.

Another training method is “unsupervised learning”. In the training by the unsupervised learning, the image samples do not need to be labelled for the above-mentioned feature labels. The image recognition model just learns to recognize the features in the image samples. As a result, when the image recognition model runs at the worksite practically, although the image recognition model trained no more than the unsupervised learning can recognize multiple features in the product image, the image recognition model fails to recognize whether any feature recognized in the product image is abnormal or not.

In conclusion, the image recognition model trained no more than the supervised learning, or no more than the unsupervised learning, has the shortcoming as mentioned above, thereby limiting the application of the image recognition model running at the worksite practically, and should be further improved.

### SUMMARY OF THE INVENTION

An objective of the present invention is to provide a system and a method to assess abnormality to overcome the shortcoming that an image recognition model trained no more than the supervised learning fails to recognize unknown abnormalities, and overcome another shortcoming that an image recognition model trained no more than the unsupervised learning fails to recognize whether any feature is abnormal or not.

The system to assess abnormality of the present invention is adapted to be connected to an image capturing device and comprises multiple classification models and a processing module. Each one of the classification models is alternately trained by supervised learning and unsupervised learning. Parameters of the classification models are not identical. The processing module is connected to the classification models, receives a test image from the image capturing device, and outputs the test image to the classification models to respectively obtain multiple feature vectors of test images from the classification models and to generate an abnormality assessment information.

The method to assess abnormality of the present invention is performed by a processing module and comprises: receiving a test image from an image capturing device, and outputting the test image to multiple classification models to respectively obtain multiple feature vectors of test images from the classification models, wherein each one of the classification models is alternately trained by supervised learning and unsupervised learning, and parameters of the classification models are not identical; and generating an abnormality assessment information based on the feature vectors of test images.

According to the system and the method of the present invention to assess abnormality, each one of the classification models is alternately trained by the supervised learning and the unsupervised learning, so as to have the characteristics of both the supervised learning and the unsupervised learning. The abnormality assessment information generated by the present invention can indicate not only known abnormalities, but also unknown abnormalities, thereby overcoming the shortcoming that an image recognition model trained no more than the supervised learning fails to recognize unknown abnormalities, and overcoming another shortcoming that an image recognition model trained no more than the unsupervised learning fails to recognize whether any feature is abnormal or not.

### BRIEF DESCRIPTION OF THE DRAWINGS

FIG. 1 is a block diagram of an embodiment of the system to assess abnormality of the present invention;

FIG. 2 is a schematic top view of a tile production line as an application example of the present invention;

FIG. 3 is a block diagram of the system of the present invention during a training procedure;

FIG. 4 is a schematic diagram of a low-dimensional space distribution formed by the feature vectors of training;

FIG. 5 is a block diagram of another embodiment of the system to assess abnormality of the present invention;

FIG. 6 is a schematic diagram depicting an abnormal risk recognized in a test image of the present invention;

FIG. 7 is a schematic diagram depicting no abnormal risk recognized in a test image of the present invention; and

FIG. 8 is a flow chart of an embodiment of the method to assess abnormality of the present invention.

### DETAILED DESCRIPTION OF PREFERRED EMBODIMENT(S)

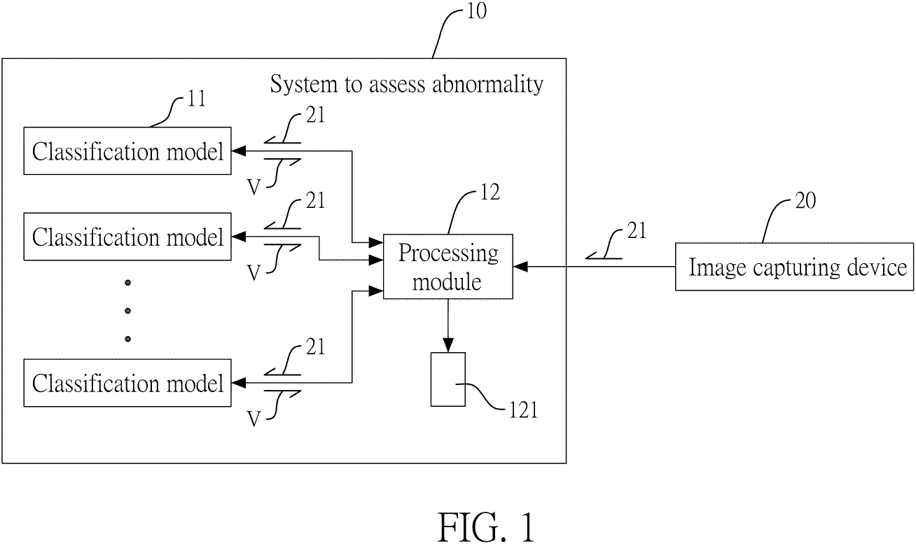

With reference to FIG. 1, an embodiment of a system 10 to assess abnormality of the present invention comprises multiple classification models 11 and a processing module 12. For example, the system 10 may be established in a personal computer, an industrial personal computer, or a server. The system 10 is adapted to be connected to an image capturing device 20. The image capturing device 20 may be a digital camera.

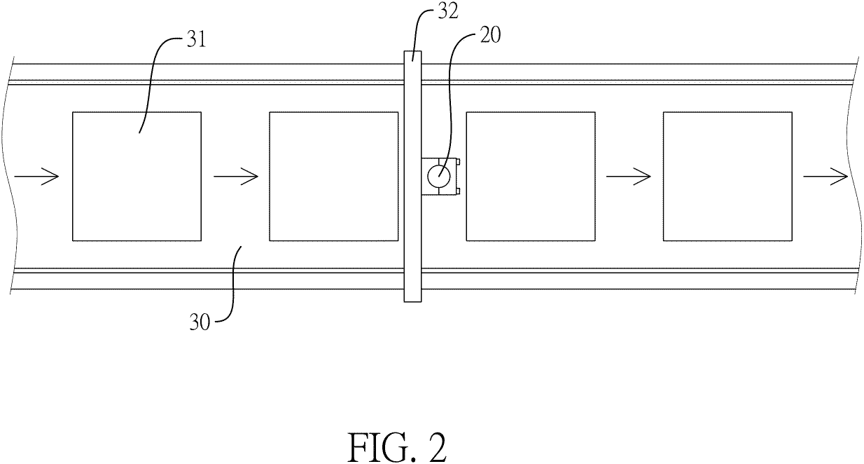

The present invention may be applied to a tile production line as an example. The application of the present invention should not be limited to the tile production line. With reference to FIG. 2, the tile production line comprises a conveyor belt 30. The conveyor belt 30 is used to convey tiles 31. The image capturing device 20 may be mounted on a support bracket 32 and above the conveyor belt 30. When a piece of a tile 31 enters an image-capturing area of the image capturing device 20, the image capturing device 20 may be triggered to photograph and generate a test image 21. Hence, the tile 31 is photographed in the test image 21.

In the present invention, the classification models 11 are artificial intelligence models, such as convolutional neural networks (CNN) models. Program codes/data of the classification models 11 may be stored in a computer-readable medium, such as a traditional hard disk drive (HDD), a solid-state drive (SSD), or a cloud-storage drive. The processing module 12 has function of data processing. For example, the processing module 12 may be implemented by a central processing unit (CPU) or a graphics processing unit (GPU). Parameters of the classification models 11 are not identical (i.e.: a part of their parameters could be the same and another part of their parameters could be different, or the parameters of the classification models are entirely different from each other). For example, the parameters may include learning rates, weights, loss functions, activation functions, optimizers, and so on. Besides, training samples for the classification models 11 are not identical (i.e.: a part of their training samples could be the same and another part of their training samples could be different, or the training samples of the classification models are entirely different from each other). As a result, the classification models 11 respectively have different classifying specialties. The processing module 12 is connected to the classification models 11 to collaborate with the classification models 11. Namely, the processing module 12 and the classification models 11 form an abnormality decision configuration of multi-model ensemble classification.

Therefore, the processing module 12 receives a test image 21 from the image capturing device 20, and outputs the test image 21 to the classification models 11 to respectively obtain multiple feature vectors of test images V from the classification models 11, and to generate an abnormality assessment information 121 according to the feature vectors of test images V. The abnormality assessment information 121 may indicate a condition, such as high risk, low risk, or non-risk (normal). In an embodiment of the present invention, the abnormality assessment information 121 may be a value quantized from a risk level. For example, the abnormality assessment information 121 may be numbers for respectively corresponding to different risk levels. Number 1 to number 5 respectively indicate a lower risk level to a higher risk level.

The training principle to the classification models 11 is described as follows. Each one of the classification models 11 is a model alternately and repeatedly trained by supervised learning and unsupervised learning. The computer-readable medium stores multiple training samples. The training samples include multiple normal-image samples as a data source for the unsupervised learning. Besides, the training samples include multiple abnormal-image samples with feature labels as a data source for the supervised learning, wherein the abnormal-image samples and the feature labels may correspond to different abnormal risk levels. The training samples for any two of the classification models 11 are not identical. Namely, in any two of the classification models 11, the normal-image samples for training one classification model 11 are not identical to the normal-image samples for training the other classification model 11, and the abnormal-image samples for training one classification model 11 are not identical to the abnormal-image samples for training the other classification model 11.

The abnormal-image samples may comprise at least one of real abnormal image data, open-source image data, and composite image data, but are not limited to the real abnormal image data, the open-source image data, and the composite image data. The real image data may be the original image files captured by the image capturing device 20, wherein the original image files have abnormal parts. The open-source image data may be image files obtained from open-source databases, and such image files are provided to aid machine learning for image features. The open-source databases may be food-101, Birdsnap, and so on. The composite image data may be image files processed by an image editing software. For example, the user can operate the image editing software to create an abnormal part for recognition in an image sample, or to superimpose an object of a foreign matter on the image sample. By doing so, the contents of the abnormal-image samples could be customized and diversified.

During a training procedure of the classification models 11, the processing module 12 sets file reading paths for the classification models 11 by program commands. For example, each one of the classification models 11 reads a part of the training samples stored in the computer-readable medium for training, wherein the part of the training samples can be randomly selected. Or, a particular part of the training samples can be selected for training one of the classification models 11. In other words, such part of the training samples is equivalent to a subset. Due to above-mentioned random selection for the training samples, during the training procedure of each one of the classification models 11, the classification model 11 may alternately and repeatedly read the normal-image samples and the abnormal-image samples with their feature labels. In addition, the training samples for training any two of the classification models 11 are not identical. The purpose that each one of the classification models 11 is alternately and repeatedly trained by the supervised learning and the unsupervised learning is implemented.

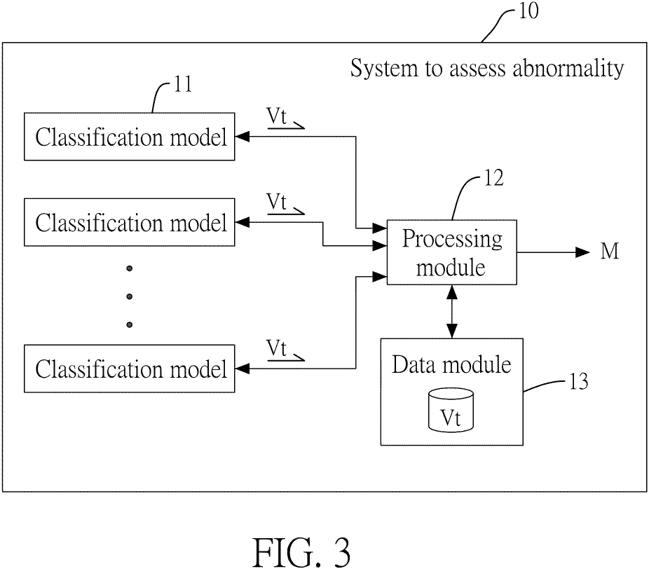

In addition, by “classification” as a technique to extract features from data, when a normal-image sample is inputted into the classification model 11, the output data of the classification model 11 is a feature vector of training. The feature vector of training reflects a feature of the normal-image sample recognized by the classification model 11. Similarly, when an abnormal-image sample with its feature label is inputted into the classification model 11, the output data of the classification model 11 is another feature vector of training. Said another feature vector of training reflects a feature, such as an abnormal feature, of the abnormal-image sample recognized by the classification model 11. Hence, when the classification models 11 complete the training, the classification models 11 respectively generate multiple feature vectors of training. With reference to FIG. 3, the present invention may further comprise a data module 13. The data module 13 may be established in the computer-readable medium. The data module 13 is connected to the processing module 12. The data module 13, the classification models 11, and the processing module 12 may collaborate with each other. The data module 13 stores the feature vectors of training Vt.

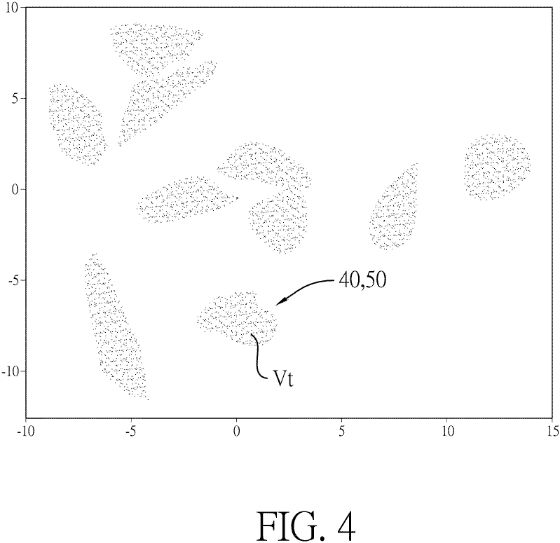

The supervised learning and the unsupervised learning are alternately and repeatedly adopted for training in the present invention, such as in sequence of the supervised learning, the unsupervised learning, the supervised learning, the unsupervised learning, and so on. To facilitate understanding, after the training, the feature vectors of training Vt generated by the classification models 11 could be referred to the low-dimensional space distribution as shown in FIG. 4. In FIG. 4, each one of the feature vectors of training Vt corresponds to a point, and multiple groups 40 are formed by multiple points respectively. The feature vectors of training Vt in a same group 40 have features corresponding to similar risk attributes. For example, the feature vectors of training Vt corresponding to the risk attributes of normal features, low-risk features, and high-risk features are collected in different groups 40 respectively. In other words, each one of the groups 40 has the feature vectors of training Vt generated by the classification models 11 based on the normal-image samples and the abnormal-image samples. The feature vectors of training Vt, which are generated according to the normal-image samples, in the groups 40 may correspond to the risk attribute of the normal feature. For example, the risk attribute of the abnormal-image sample having a small foreign matter, such as a piece of a fragment as the abnormal feature, may be low risk. The risk attribute of the abnormal-image sample having a large foreign matter, such as an L-shaped inner hexagonal spanner as the abnormal feature, may be high risk.

In order to define the regularity of the feature vectors of training Vt, the feature vectors of training Vt should be processed by vector quantization to be values, and then the regularity is determined. In the embodiment of the present invention, as shown in FIG. 4, the processing module 12 performs a space clustering based on the feature vectors of training Vt to form multiple feature clusters 50. The feature clusters 50 respectively correspond to the above-mentioned groups 40. Hence, the processing module 12 quantizes the feature vectors of training Vt as multiple score values. For example, k-means clustering is a method of vector clustering and quantizing. The processing module 12 generates a discrimination mechanism M via a linear regression based on the score values. The discrimination mechanism M can reflect the regularity of the feature vectors of training Vt. Therefore, the processing module 12 stores program codes/data of the discrimination mechanism M. With reference to FIG. 1, when the processing module 12 receives the feature vectors of test images V from the classification models 11, the processing module 12 may generate the abnormality assessment information 121 via the discrimination mechanism M based on the feature vectors of test images V as described as follows.

As mentioned above, the classification models 11 respectively have different classifying specialties. The processing module12 defines weight values to the classification models 11 respectively, such that each one of the classification models 11 has a corresponding weight value for indicating the importance of the classification model 11. When the processing module 12 receives the test image 21 from the image capturing device 20, the processing module 12 outputs the test image 21 to the classification models 11. Each one of the classification models 11 outputs one feature vector of test images V according to the test image 21. As a result, the processing module 12 may receive multiple feature vectors of test images V from the classification models 11 respectively. The processing module 12 generates multiple abnormality levels of the feature vectors of test images V by the discrimination mechanism M, wherein the information of one abnormality level is generated via the discrimination mechanism M from one feature vectors of test images V. Based on the classification models 11 respectively having different classifying specialties, it is to be understood that the abnormality level of the feature vectors of test images V generated by a part of the classification models 11 could be high risk, and the abnormality level of the feature vectors of test images V generated by another part of the classification models 11 could be low risk. Hence, the processing module 12 generates the abnormality assessment information 121 according to the weight values of the classification models 11 and the abnormality levels of the classification models 11.

As mentioned above, the abnormality assessment information 121 may be a value quantized from a risk level. For example, number 1 to number 5 respectively indicate a lower risk level to a higher risk level. The processing module 12 defines level “1” as low risk, and defines level “5” as high risk. The abnormality assessment information 121 generated by the processing module 12 may be “1” when the results determined by most of the classification models 11 or the classification models 11 with higher weight values is low risk. The rest may be deduced by analogy. The abnormality assessment information 121 generated by the processing module 12 may be “5” when the results determined by most of the classification models 11 or the classification models 11 with higher weight values are high risk.

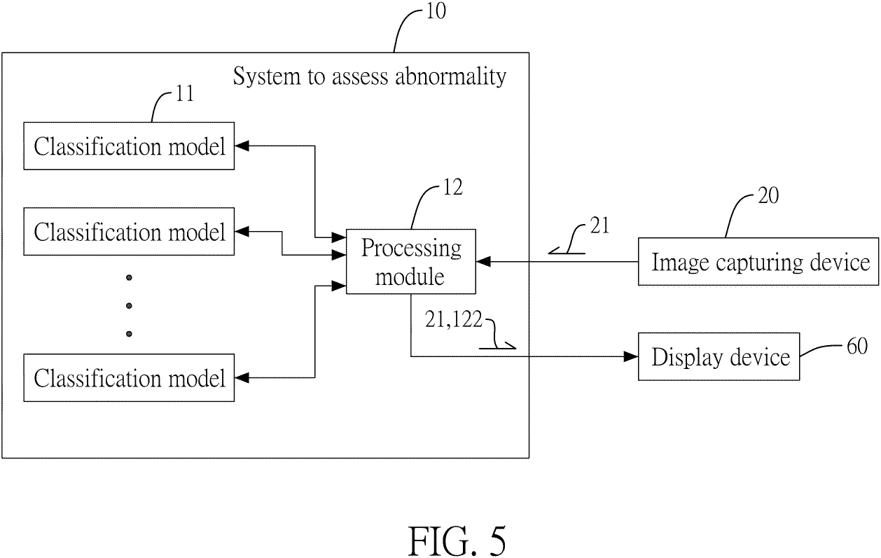

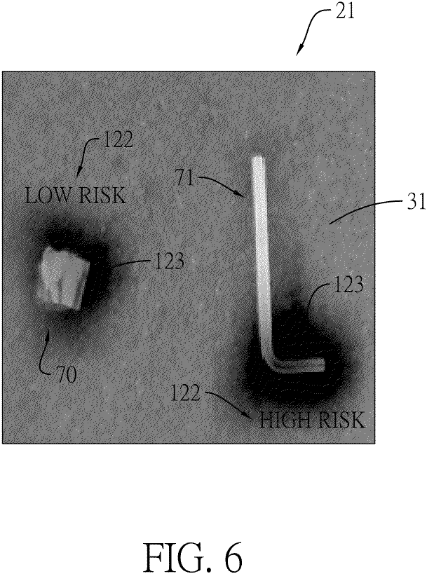

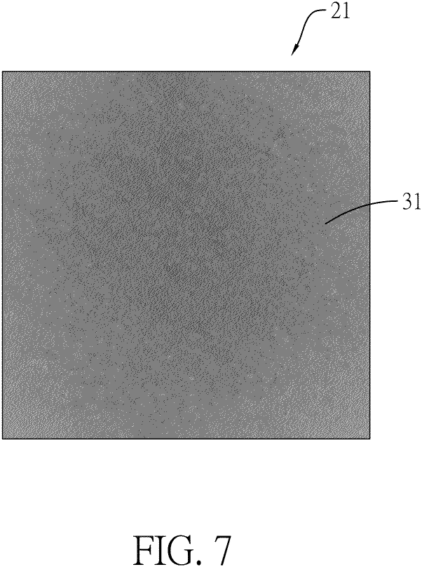

With reference to FIG. 5, the system 10 of the present invention may be further connected to a display device 60. The display device 60 may be, but is not limited to, a liquid crystal display or a touch screen display. The display device 60 may be equipped at the worksite. The processing module 12 sets a risk indicating information 122 according to the abnormality assessment information 121. The format of the risk indicating information 122 can be preset texts, symbols, or codes. The processing module 12 superimposes the risk indicating information 122 on the test image 21 to be transmitted to the display device 60 for displaying. For example, the risk indicating information 122 may include preset texts such as “HIGH RISK” or “LOW RISK”. Besides, in order to enhance visual effect for the staff at the worksite to instantly observe which product is recognized abnormal, when the risk indicating information 122 is superimposed on the test image 21 to be transmitted to the display device 60 for displaying, the processing module 12 applies a visualized segmentation to an abnormality part in the test image 21, and displays the risk indicating information 122 at the position of the visualized segmentation. FIG. 6 is an example that the present invention recognizes abnormalities. A piece of a tile 31 is in the test image 21. A piece of a fragment 70 and an L-shaped inner hexagonal spanner 71 are recognized as abnormality parts on the surface of the tile 31. Compared with FIG. 7 showing another test image 21 that no abnormality part is recognized, FIG. 6 shows the visualized segmentations 123. The visualized segmentation 123 is a pattern block displayed at the abnormality part in the test image 21. The pattern block may be, but is not limited to, a gradient color block. The risk indicating information 122 of “HIGH RISK” and “LOW RISK” corresponding to the fragment 70 and the L-shaped inner hexagonal spanner 71 are displayed at the position of the visualized segmentations 123 respectively.

In the above description, the processing module 12 may transmit the test image 21 to a convolutional neural network to compute, and receives a feature map from the convolutional neural network via a class activation mapping (CAM). The feature map is to be the risk indicating information 122 or the visualized segmentations 123. Said class activation mapping (CAM) can be GradCAM, GradCAM++, or Score-CAM that are conventional arts and are not described in detail herein.

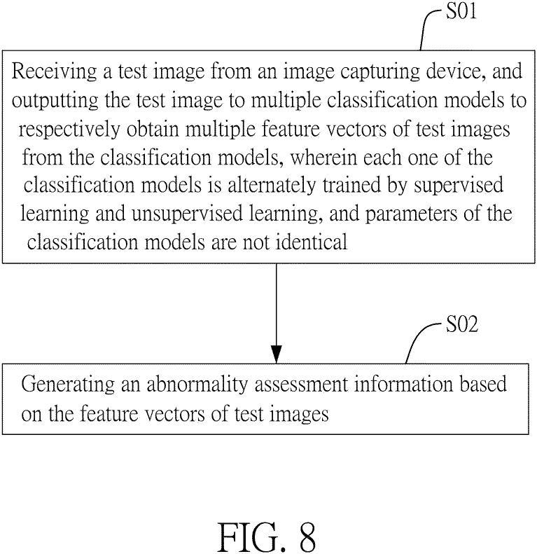

In summary, FIG. 8 depicts an embodiment of the method to assess abnormality of the present invention. The method comprises STEP S01: receiving the test image 21 by the processing module 12 from the image capturing device 20, and outputting the test image 21 to the classification models 11 to respectively obtain the feature vectors of test images V from the classification models 11, wherein each one of the classification models 11 is alternately trained by the supervised learning and the unsupervised learning, and the parameters of the classification models 11 are not identical; and STEP S02: generating an abnormality assessment information 121 by the processing module 12 based on the feature vectors of test images V.

In one embodiment of the present invention, the processing module 12 reads the feature vectors of training Vt from the data module 13. The feature vectors of training Vt are data generated by the classification models 11 during the training procedure. The processing module 12 performs a space clustering based on the feature vectors of training Vt to form multiple feature clusters 50, so as to quantize the feature vectors of training Vt as multiple score values and generate a discrimination mechanism M via the linear regression based on the score values to generate the abnormality assessment information 121.

In one embodiment of the present invention, the processing module 12 defines weight values to the classification models 11 respectively. The processing module 12 generates multiple abnormality levels of the feature vectors of test images Vt by the discrimination mechanism M according to the weight values of the classification models 11 and the discrimination mechanism M. The processing module 12 generates the abnormality assessment information 121 according to the weight values of the classification models 11 and the abnormality levels.

In one embodiment of the present invention, the processing module 12 sets the risk indicating information 122 according to the abnormality assessment information 121, and superimposing the risk indicating information 122 on the test image 21 to be transmitted to the display device 60 for displaying.

In one embodiment of the present invention, in the step of setting the risk indicating information 122, the processing module 12 transmits the test image 21 to a convolutional neural network, and receives a feature map from the convolutional neural network via a class activation mapping (CAM) to be the risk indicating information 122.

In one embodiment of the present invention, in the step of superimposing the risk indicating information 122 on the test image 21 to be transmitted to the display device 60 for displaying, the visualized segmentation 123 is performed on the abnormality part in the test image 21 by the processing module 12, and the risk indicating information 122 is displayed at the position of the visualized segmentation 123.

In one embodiment of the present invention, each one of the classification models 11 is alternately and repeatedly trained by the supervised learning and the unsupervised learning. During the training procedure, the normal-image samples are adopted by the supervised learning to train each one of the classification models 11, and multiple abnormal-image samples are adopted by the unsupervised learning to train each one of the classification models 11. The normal-image samples for training one of the classification models 11 are not identical to the normal-image samples for training another one of the classification models 11. The abnormal-image samples for training one of the classification models 11 are not identical to the abnormal-image samples for training another one of the classification models 11.

In one embodiment of the present invention, each one of the classification models 11 is an artificial intelligence model. The abnormal-image samples comprise at least one of real abnormal image data, open-source image data, and composite image data.

In conclusion, each one of the classification models 11 is alternately trained by the supervised learning and the unsupervised learning, so as to have the characteristics of both the supervised learning and the unsupervised learning. The classification models 11 respectively have different classifying specialties. The abnormality assessment information 121 generated by the present invention may indicate known abnormalities and unknown abnormalities. Especially, the abnormality part in the test image 21 is visualized in a much better way, and the risk is marked accordingly. The practicability of the present invention is significantly enhanced.

The above details only a few embodiments of the present invention, rather than imposing any forms of limitation to the present invention. Any professionals in related fields of expertise relating to the present invention, within the limitations of what is claimed, are free to make equivalent adjustments regarding the embodiments mentioned above. However, any simple adjustments and equivalent changes made without deviating from the present invention would be encompassed by what is claimed for the present invention.

What is claimed is:

1. A system to assess abnormality, adapted to be connected to an image capturing device and comprising:
multiple classification models, wherein each one of the classification models is alternately trained by supervised learning and unsupervised learning, and parameters of the classification models are not identical; and
a processing module connected to the classification models, and configured to receive a test image from the image capturing device, and to output the test image to the classification models to respectively obtain multiple feature vectors of test images from the classification models and to generate an abnormality assessment information.

2. The system as claimed in claim 1 further comprising a data module connected to the classification models and the processing module, and configured to store multiple feature vectors of training generated by the classification models during a training procedure of the classification models;
wherein the processing module performs a space clustering based on the feature vectors of training to form multiple feature clusters, so as to quantize the feature vectors of training as multiple score values and generate a discrimination mechanism via a linear regression based on the score values to generate the abnormality assessment information.

3. The system as claimed in claim 2, wherein the processing module defines respective weight values of the classification models, generates multiple abnormality levels of the feature vectors of test images by the discrimination mechanism according to the weight values of the classification models and the discrimination mechanism, and generates the abnormality assessment information according to the respective weight values of the classification models and the abnormality levels.

4. The system as claimed in claim 1, wherein
the system is connected to a display device; and
the processing module sets risk indicating information and superimposes the risk indicating information on the test image to be transmitted to the display device for displaying.

5. The system as claimed in claim 4, wherein the processing module transmits the test image to a convolutional neural network, and receives a feature map from the convolutional neural network via a class activation mapping (CAM) to be the risk indicating information.

6. The system as claimed in claim 4, wherein when the risk indicating information is superimposed on the test image to be transmitted to the display device for displaying, a visualized segmentation is performed by the processing module on an abnormality part in the test image, and the risk indicating information is displayed at a position of the visualized segmentation.

7. The system as claimed in claim 1, wherein
each one of the classification models is alternately and repeatedly trained by supervised learning and unsupervised learning;
during a training procedure, multiple normal-image samples are adopted by the supervised learning to train each one of the classification models, and multiple abnormal-image samples are adopted by the unsupervised learning to train each one of the classification models; and
the normal-image samples and the abnormal-image samples for training one of the classification models are not identical to the normal-image samples and the abnormal-image samples for training another one of the classification models.

8. The system as claimed in claim 7, wherein
each one of the classification models is an artificial intelligence model; and
the abnormal-image samples comprise at least one of real abnormal image data, open-source image data, and composite image data.

9. A method to assess abnormality performed by a processing module and comprising:
receiving a test image from an image capturing device, and outputting the test image to multiple classification models to respectively obtain multiple feature vectors of test images from the classification models, wherein each one of the classification models is alternately trained by supervised learning and unsupervised learning, and parameters of the classification models are not identical; and
generating an abnormality assessment information based on the feature vectors of test images.

10. The method as claimed in claim 9 further comprising:
reading multiple feature vectors of training from a data module, wherein the feature vectors of training are data generated by the classification models during a training procedure;
performing a space clustering based on the feature vectors of training to form multiple feature clusters, so as to quantize the feature vectors of training as multiple score values and generate a discrimination mechanism via a linear regression based on the score values to generate the abnormality assessment information.

11. The method as claimed in claim 10 further comprising:
defining weight values to the classification models respectively;
generating multiple abnormality levels of the feature vectors of test images by the discrimination mechanism according to the weight values of the classification models and the discrimination mechanism; and
generating the abnormality assessment information according to the weight values of the classification models and the abnormality levels.

12. The method as claimed in claim 9 further comprising:
setting a risk indicating information according to the abnormality assessment information, and superimposing the risk indicating information on the test image to be transmitted to a display device for displaying.

13. The method as claimed in claim 12, wherein in the step of setting the risk indicating information, the processing module transmits the test image to a convolutional neural network, and receives a feature map from the convolutional neural network via a class activation mapping (CAM) to be the risk indicating information.

14. The method as claimed in claim 12, wherein in the step of superimposing the risk indicating information on the test image to be transmitted to the display device for displaying, a visualized segmentation is performed on an abnormality part in the test image, and the risk indicating information is displayed at a position of the visualized segmentation .

15. The method as claimed in claim 9, wherein
each one of the classification models is alternately and repeatedly trained by supervised learning and unsupervised learning;
during a training procedure, multiple normal-image samples are adopted by the supervised learning to train each one of the classification models, and multiple abnormal-image samples are adopted by the unsupervised learning to train each one of the classification models; and
the normal-image samples and the abnormal-image samples for training one of the classification models are not identical to the normal-image samples and the abnormal-image samples for training another one of the classification models.

16. The method as claimed in claim 15, wherein
each one of the classification models is an artificial intelligence model; and
the abnormal-image samples comprise at least one of real abnormal image data, open-source image data, and composite image data.
